(19) United States
(12) Patent Application Publication
(10) Pub. No.: US 2019/0266548 A1
(43) Pub. Date: Aug. 29, 2019

(54) Project Progress Prediction Device and Project Progress Prediction System

(71) Applicant: Hitachi, Ltd., Tokyo (JP)

(72) Inventors: Teppei INOUE, Tokyo (JP); Akihisa TSUJIBE, Tokyo (JP)

(21) Appl. No.: 16/201,499

(22) Filed: Nov. 27, 2018

(30) Foreign Application Priority Data
Feb. 23, 2018 (JP) 2018-30852

(51) Int. Cl. G06Q 10/06; G06N 7/00; G06Q 10/04

(52) U.S. Cl. CPC G06Q 10/063118; G06Q 10/04; G06N 7/005

(57) ABSTRACT

To predict a required completion date with high accuracy for each process of a product of which registration information including the delivery date of a project changes frequently. A project progress prediction device includes: a storage unit that stores log information which is a change history of an attribute value of a project and a feature amount of a delivery date including the number of elapsed days for each process; an attribute value selection unit that selects an attribute value having a predetermined correlation with the delivery date of the project using the log information; a past project extraction unit that extracts a completed project having the attribute value similar to that of a prediction target project from the storage unit using the selected attribute value, and estimates a lead time for each of the feature amounts for non-completed processes of the prediction target project using the feature amount of the delivery date of the extracted completed project; and a progress prediction unit that integrates the estimated lead times between the feature amounts and predicts a probability of a required completion date for each process of the prediction target project.

### CROSS REFERENCE TO RELATED APPLICATIONS

This application claims priority under 35 U.S.C. § 119 from Japanese Patent Application No. 2018-030852, filed Feb. 23, 2018, the entire disclosure of which is herein expressly incorporated by reference.

### TECHNICAL FIELD

The present invention relates to a project progress prediction device and a project progress prediction system.

### BACKGROUND ART

In infrastructure products such as elevators and storages, an arrangement of procurement, production, and the like is performed according to a required completion date of each process such as design, production, shipment, and the like. Here, in general infrastructure products, since a delivery date may be frequently changed due to external factors such as delays in payment and delays in building construction at a product delivery place, it is necessary to predict the required completion date of each process in a timely manner. As a technology for predicting the required completion date for each process, there is a technology described in PTL 1, in which, for example, an approval time from application to approval completion can be predicted.

### CITATION LIST

### Patent Literature

PTL 1: JP-A-2014-238658

### SUMMARY OF INVENTION

### Technical Problem

According to the technology described in PTL 1, by extracting a past project having information similar to the registration information at the time of application of the project, and by predicting required time for each approval, the approval time up to the application completion is predicted. However, in the technology described above, since the approval time is predicted using the registration information at the time of application of the project, if the technology is applied to an infrastructure product delivery project where the registration information of the project is changed frequently, there is a high possibility that a prediction accuracy is low. In addition, in the technology described above, the past project similar to a prediction target project is extracted focusing on factors such as the day of the week of the application date and a content of the application, however, it is necessary to select any focused factors. Therefore, if there are a plurality of candidate factors, factors to be focused on cannot be appropriately determined, and as a result, the prediction accuracy cannot be secured. The present invention has been made in view of the above circumstances, and has an object of predicting the required completion date for each process with high accuracy.

### Solution to Problem

In order to solve the problems described above, a project progress prediction device includes: a storage unit that stores log information which is a change history of an attribute value of a project and a feature amount of a delivery date including the number of elapsed days for each process; an attribute value selection unit that selects an attribute value having a predetermined correlation with the delivery date of the project using the log information; a past project extraction unit that extracts a completed project having the attribute value similar to that of a prediction target project from the storage unit using the selected attribute value, and estimates a lead time for each of the feature amounts for non-completed processes of the prediction target project using the feature amount of the delivery date of the extracted completed project; and a progress prediction unit that integrates the estimated lead times between the feature amounts and predicts a probability of a required completion date for each process of the prediction target project.

### Advantageous Effects of Invention

According to the present invention, it is possible to predict the required completion date with high accuracy for each process of the products of which registration information including a delivery date of the project changes frequently. The problems, configurations, and effects other than those described above will be clarified by the description of the embodiments below.

### BRIEF DESCRIPTION OF DRAWINGS

FIG. 1 is a diagram illustrating an example of functional blocks of a project progress prediction device and a project progress prediction system.

FIG. 2 is a diagram illustrating an example of a data structure of past project information.

FIG. 3 is a diagram illustrating an example of a data structure of feature amount information.

FIG. 4 is a diagram illustrating an example of a data structure of attribute value information.

FIG. 5 is a diagram illustrating an example of a data structure of ordered project information.

FIG. 6 is a diagram illustrating an example of a data structure of required completion date information.

FIG. 7 is a diagram illustrating an example of a data structure of set information.

FIG. 8 is a diagram illustrating an example of a hardware configuration of the project progress prediction device.

FIG. 9 is a flowchart illustrating an example of project progress prediction processing.

FIG. 10 is a diagram illustrating an example in which an intra-class error and an inter-class error are visualized.

FIG. 11 is a diagram illustrating an example of results of calculation the intra-class error and the inter-class error.

FIG. 12 is a diagram illustrating an example of result of calculating a correlation ratio.

FIG. 13 is a diagram illustrating an example of a result of calculation of the probability for determining a combination of attribute values to be extracted.

FIG. 14 is a diagram illustrating an example of trends for each feature amount of log information.

FIG. 15 is a diagram illustrating an example of a result of combination of the trends for each feature amount of the log information.

FIG. 16 is a diagram illustrating an example of an output screen.

### DESCRIPTION OF EMBODIMENTS

Hereinafter, an embodiment of the present invention will be described using the drawings. In this description, the term “project” is assumed to refer to a proposal having an attribute value including a type of industry, a delivery area, a product type, and a contract amount that can be a characteristic of the project and an order received from a customer. In the present description, the type of industry, the delivery area, the product type, and the contract amount are taken as the attribute value, but the attribute value is not limited thereto.

In the present description, the “process” indicates each stage obtained by dividing the states of the project for the sake of convenience from a time the order is received to a time the product is delivered to the customer. In the present description, the process is assumed to be divided into five stages of order reception, design, production, shipping, and delivery, and the process is assumed to be progressed in that order, however, the process is not limited to the five stages and not limited to be progressed in that order.

In addition, in the present description, the delivery date is assumed to be set for each project and is assumed to refer to a scheduled date of delivering the product to the customer. The registration information of the project is assumed to include the attribute value, the delivery date and the information on the process completed up to a predetermined time point. In the present description, the registration information is assumed to be configured to include the attribute value, the delivery date, and the information on the process completed up to current time point, but not limited thereto.

In addition, in the present description, the log information is assumed to refer to a change history of the registration information of the project, and the log information is assumed to be expressed by a feature amount such as the number of elapsed days from the registration of the project and the change history of the delivery date. In the present description, the six feature amounts of the log information are assumed to be the number of elapsed days from the order reception to the design, the number of elapsed days from the design to the production, the number of elapsed days from the production to the shipment, the number of elapsed days from the shipment to the delivery, the number of times of changing the delivery date, and the content of changing the delivery date, however, the feature amounts are not limited thereto.

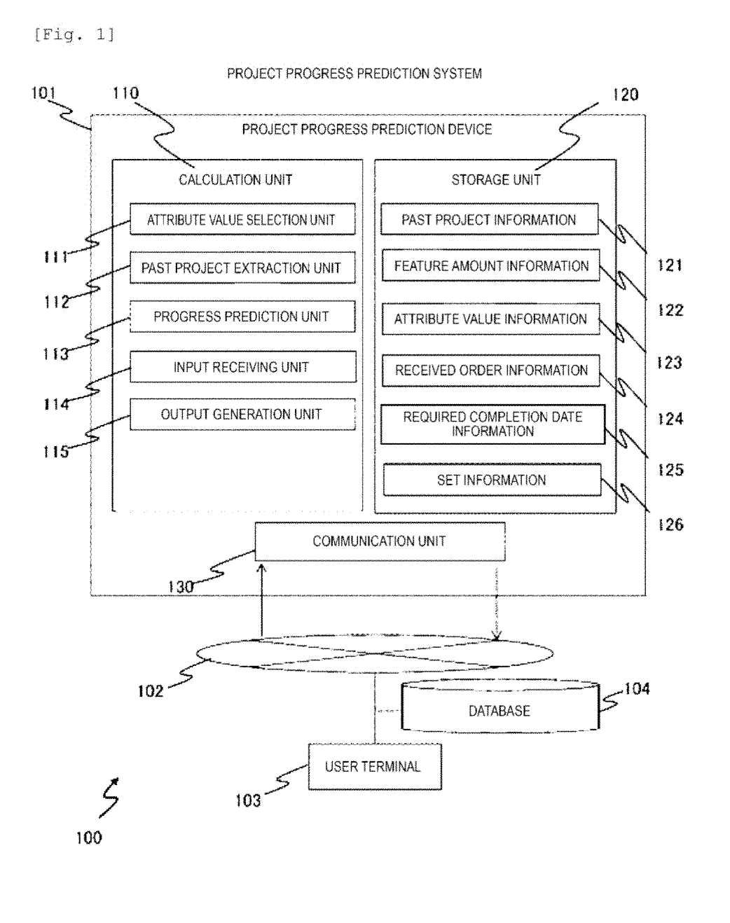

FIG. 1 is a diagram illustrating an example of functional blocks of a project progress prediction device 101 and a project progress prediction system 100 in the present embodiment. The project progress prediction system 100 in the present embodiment includes the project progress prediction device 101, a user terminal 103 used by a user, and a database device 104 storing the data of the past project information, and those are communicably connected to each other via a network 102.

The user terminal 103 is an information processing device such as a personal computer (PC). The user can input ordered project information, a prediction establishment date, a reference period of the past project to be used in the prediction, an allowance range which is set information necessary for processing by the project progress prediction device 101, and an allowance probability into the user terminal 103, and the user terminal 103 has a function of transmitting the received ordered project information, the prediction establishment date, the past project reference period, the allowance range, and the allowance probability to the project progress prediction device 101 via the network 102.

Here, the ordered project information is various kinds of information items including the number of days related to the prediction target project. In addition, the prediction target project is a project of which the delivery to the customer has not been completed. The prediction establishment date is a date when the user performs the processing for predicting the required completion date of the prediction target project for each process registered in the ordered project information using the project progress prediction device 101. In addition, the user terminal 103 has a function of displaying the information output by the project progress prediction device 101 to the user.

The database device 104 is a computer using a system such as enterprise resources planning (ERP) or the like, or a database conforming thereto that stores data, or using a storage device such as network attached storage (NAS) and database management software.

The network 102 connects the user terminal 103, the database device 104, and the project progress prediction device 101 so as to communicate with each other. The network 102 is any one of a communication network using some or all of the general public lines such as local area network (LAN), wide area network (WAN), virtual private network (VPN), the Internet, and the like.

The project progress prediction device 101 is an information processing device such as a PC or a server computer, and extracts the log information of the past project information, and then, predicts the required completion date for each process of the prediction target project stored as the ordered project information using the log information of the extracted past project.

The project progress prediction device 101 includes a calculation unit 110, a storage unit 120, and a communication unit 130. The storage unit 120 stores the past project information 121, the feature amount information 122, the attribute value information 123, the ordered project information 124, the required completion date information 125, and the set information 126.

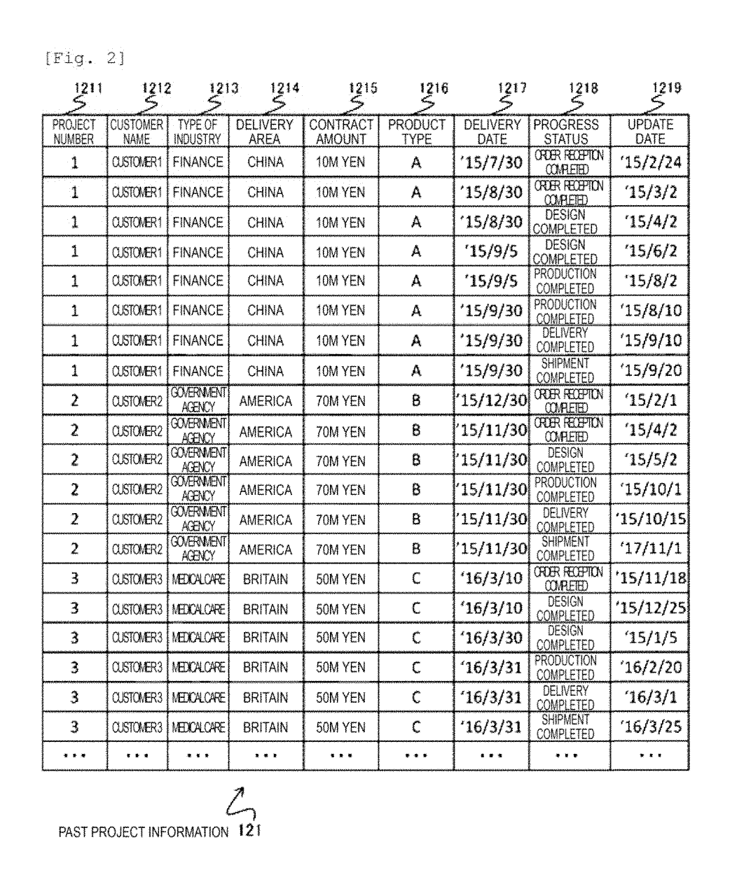

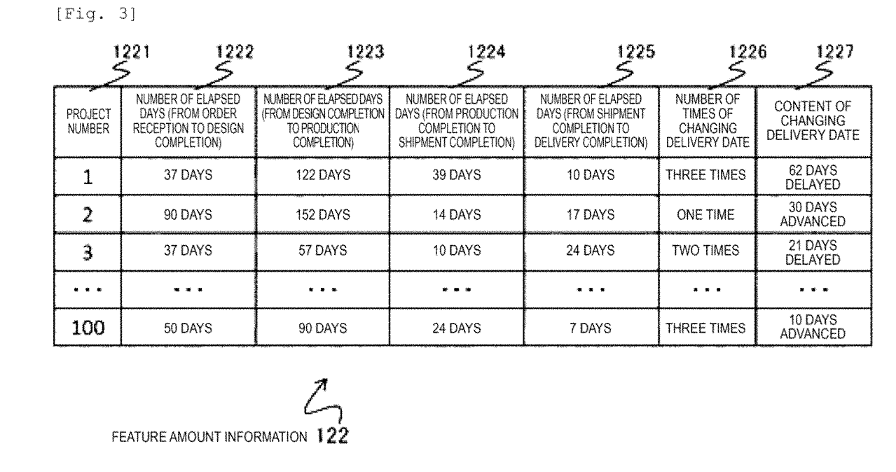

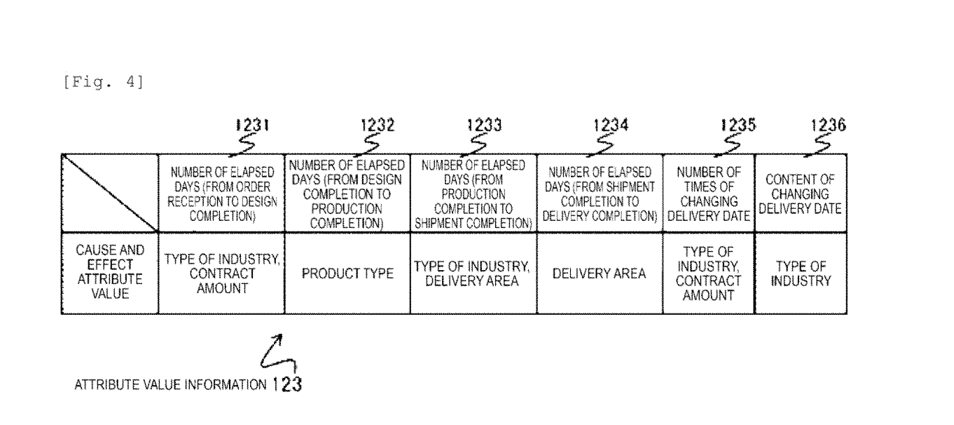

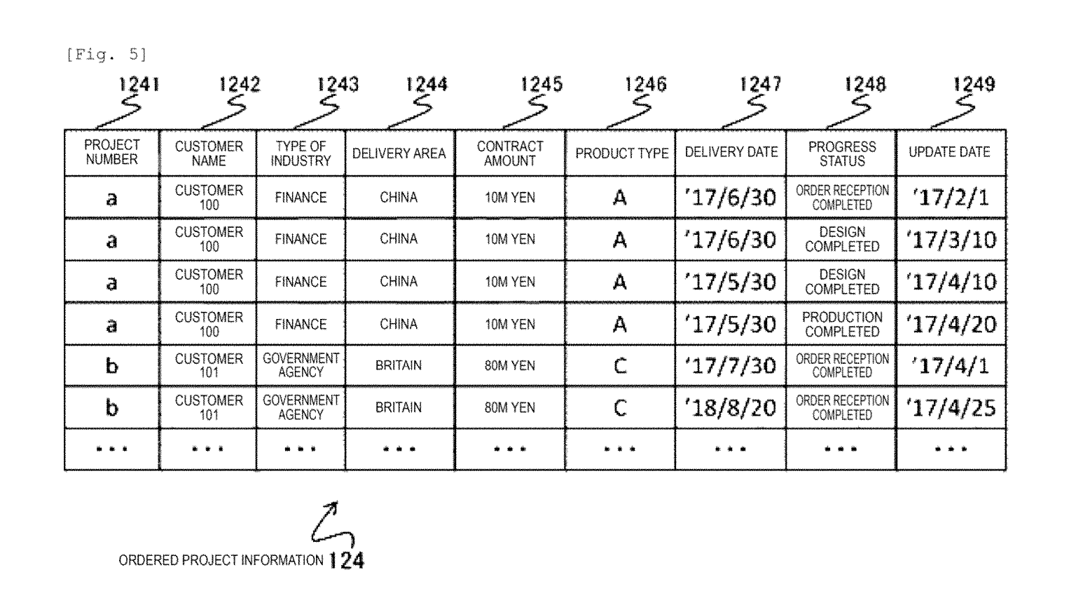

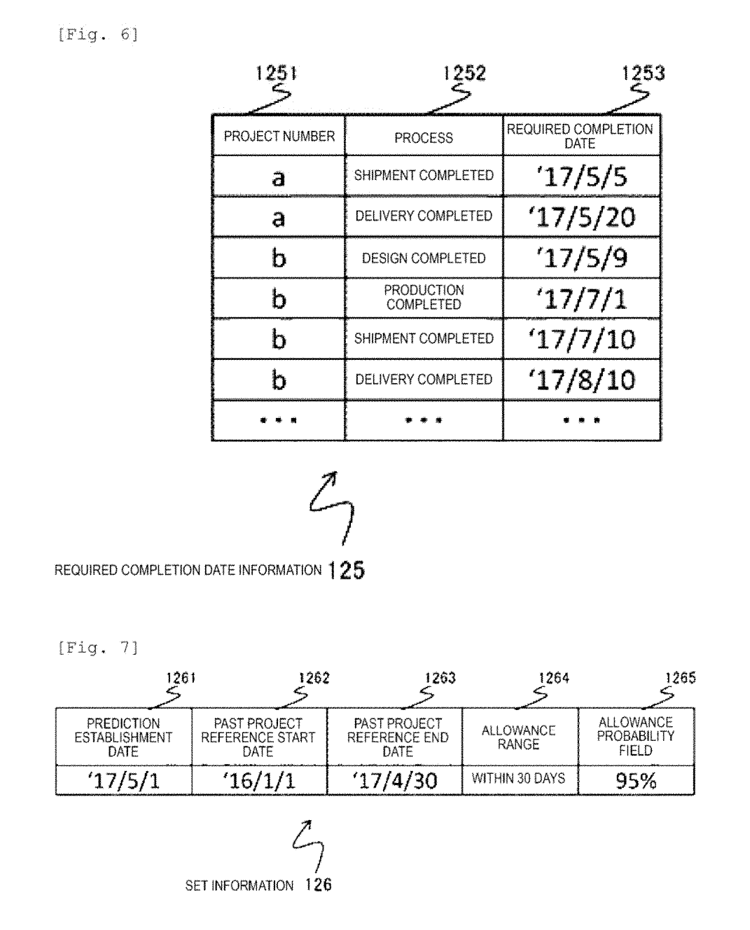

Here, an example of the past project information 121 is illustrated in FIG. 2, an example of the feature amount information 122 is illustrated in FIG. 3, an attribute value information is illustrated in FIG. 4, an example of the ordered project information 124 is illustrated in FIG. 5, an example of the required completion date information 125 is illustrated in FIG. 6, and an example of the set information 126 is illustrated in FIG. 7.

FIG. 2 is a diagram illustrating an example of a data structure of the past project information 121. Information on the registration content of the past project of which the delivery to customer is completed is stored in the past project information 121. The past project information 121 is configured with a plurality of records, and each record includes a project number field 1211, a customer name field 1212, a type of industry field 1213, a delivery area field 1214, a contract amount field 1215, a product type field 1216, a delivery date field 1217, a progress status field 1218, and an update date field 1219.

In the project number field 1211, information on the project number for identifying the project is stored. In the customer name field 1212, information on the customer name of the project is stored. In the type of industry field 1213, information on the type of industry of the customer is stored. The type of industry has predetermined categories such as “finance”, “government agency”, “medical care”, and the like.

In the delivery area field 1214, information on the delivery area to which the product is delivered is stored. The delivery area has predefined categories such as “China”, “America”, “Britain” and the like. In the contract amount field 1215, information on the contract amount of the project is stored. In the product type field 1216, information on the product type ordered by the customer is stored. The product type has predetermined categories such as “product A”, “product B”, “product C”, and the like.

In the delivery date field 1217, information on the delivery date, which is the delivery deadline for the customer, is stored. In the progress status field 1218, among the processes of the order reception, the design, the production, the shipment, and the delivery, the latest information on the process completed up to the time point of the date stored in the update date field 1219, is stored. For example, if the project of which the project number is “1” in FIG. 2, the progress status of the record of which the update date is “15/4/2” is “design completion”. This indicates that the design is completed as of the time point “15/4/2”. In the update date field 1219, information on the date when the information stored in the delivery date field 1217 and the progress status field 1218 are changed is stored.

FIG. 3 is a diagram illustrating an example of a data structure of the feature amount information. In the feature amount information 122, each feature amount (log information) of the past project is stored. The feature amount information 122 is configured with a plurality of records, and each record includes a project number field 1221, a number of elapsed days (from the order reception to the design completion) field 1222, a number of elapsed days (from the design completion to the production completion) field 1223, a number of elapsed days (from the production completion to the shipment completion) field 1224, a number of elapsed days (from the shipment completion to the delivery completion) field 1225, a number of times of changing the delivery date field 1226, and a content of changing the delivery date field 1227.

In the project number field 1221, information on a project number for identifying the project is stored. In the number of elapsed days (from the order reception to the design completion) field 1222, the number of days required for the design completion from the order reception is stored. In the number of elapsed days (from the design completion to the production completion) field 1223, the number of days required for the production completion from the design completion is stored. In the number of elapsed days (from the production completion to the shipment completion) field 1224, the number of days required for the shipment completion from the production completion is stored. In the number of elapsed days (from the shipment completion to the delivery completion) field 1225, the number of days required for the delivery completion from the shipment completion is stored.

In the number of times of changing the delivery date field 1226, the number of times of the delivery date changes from the order reception of the project to the delivery completion is stored. In the content of changing the delivery date field 1227, information on the number of advanced/delayed days of the delivery date in the record corresponding to the latest update date with reference to the delivery date in the record corresponding to the oldest update date is stored.

FIG. 4 is a diagram illustrating an example of a structure of the attribute value information. In the attribute value information 123, item names of the attribute values correlated (cause and effect relationship) with each feature amount of the log information of the past project is stored. The attribute value information 123 is configured with one record, and the record includes a number of elapsed days (from the order reception to the design completion) field 1231, a number of elapsed days (from the design completion to the production completion) field 1232, a number of elapsed days (from the production completion to the shipment completion) field 1233, a number of elapsed days (from the shipment completion to the delivery completion) field 1234, a number of times of changing the delivery date field 1235, and a content of changing the delivery date field 1236.

In the number of elapsed days (from the order reception to the design completion) field 1231, information on the attribute value correlated with the number of elapsed days from the order reception to the design completion is stored. In the number of elapsed days (from the design completion to the production completion) field 1232, information on the attribute value correlated with the number of elapsed days from the design completion to the production completion is stored.

In the number of elapsed days (from the production completion to the shipment completion) field 1233, information on the attribute value correlated with the number of elapsed days from the production completion to the shipment completion is stored. In the number of elapsed days (from the shipment completion to the delivery completion) field 1234, information on the attribute value correlated with the number of elapsed days from the shipment completion to the delivery completion. In the number of times of changing the delivery date field 1235, information on the attribute value correlated with the number of times of changing the delivery date is stored. In the content of changing the delivery date field 1236, information on the attribute value correlated with the content of changing the delivery date is stored.

FIG. 5 is a diagram illustrating an example of a data structure of the ordered project information. Particularly, in the ordered project information 124, an example of information at the time of the prediction establishment date “17/5/1” is illustrated. In the ordered project information 124, information on the prediction target project is stored. The ordered project information 124 is configured with a plurality of records, and each record includes a project number field 1241, a customer name field 1242, a type of industry field 1243, a delivery area field 1244, a contract amount field 1245, a product type field 1246, a delivery date field 1247, a progress status field 1248, and an update date field 1249.

In the project number field 1241, information on the project number for identifying the project is stored. In the customer name field 1242, information on the customer name of the project is stored. In the type of industry field 1243, information on the type of industry of the customer is stored. The type of industry has predetermined categories such as “finance”, “government agency”, “medical care” and the like.

In the delivery area field 1244, information on the delivery area of the product is stored. The delivery area has predetermined categories such as “China”, “America”, “Britain”, and the like. In the contract amount field 1245, information on the contract amount of the project is stored. In the product type field 1246, information on the product type ordered by the customer is stored. The product type has predetermined categories such as “product A”, “product B”, “product C”, and the like.

In the delivery date field 1247, information on the delivery date, which is the delivery deadline for the customer, is stored. In the progress status field 1248, among the processes of order reception, design, production, shipment, and delivery, information on the latest process that is completed up to the time point of the date stored in the update date field 1249, is stored. For example, in a case of the project of which the project number is “a” in FIG. 5, the progress status of the record of which the update date is “17/3/10” is “design completion”. This indicates that the design is completed up to the time point “17/3/10”. In the update date field 1249, information on the dates when the information stored in the delivery date field 1247 and the progress status field 1248 are changed is stored.

FIG. 6 is a diagram illustrating an example of a data structure of required completion date information. In the required completion date information 125, the result of prediction of the required completion date of the prediction target project is stored. The required completion date information 125 is configured with a plurality of records, and each record includes a project number field 1251, a process field 1252, and a required completion date field 1253.

In the project number field 1251, information on the project number for identifying the project is stored. In the process field 1252, information on the process to be predicted is stored. In the required completion date field 1253, information on the required completion date of the process stored in the process field 1252 is stored.

FIG. 7 is a diagram illustrating an example of a data structure of set information. In the set information 126, set information necessary for processing by the project progress prediction device 101 is stored. The set information 126 is configured with one record, and the record includes a prediction establishment date field 1261, a past project reference start date field 1262, a past project reference end date field 1263, an allowance range field 1264, and an allowance probability field 1265.

In the prediction establishment date field 1261, a performing date of the prediction of the required completion date for each process of the prediction target project registered in the ordered project information 124 by the user using the project progress prediction device 101, is stored. In the past project reference start date field 1262, the reference start date of the past project to be used in the prediction is stored. In the past project reference end date field 1263, a reference end date of the past project to be used in the prediction is stored. In the allowance range field 1264, information specifying an allowance range regarding a confidence interval used when the attribute value selection unit 111 selects the attribute value of the project from the log information of the past project, is stored.

In the allowance probability field 1265, an allowance probability used when the attribute value selection unit 111 selects the attribute value of the project from the log information of the past project, and used for determining whether or not the confidence interval falls within the allowance range is stored.

Returning to the description of FIG. 1, the calculation unit 110 derives an attribute value (item) correlated with each feature amount of the log information of the past project, specifies a trend (creation of a probability distribution of the lead time) for each feature amount of the log information of the past project, and calculates the probability distribution of the lead time as the prediction of the required completion date for each process. The calculation unit 110 includes an attribute value selection unit 111, a past project extraction unit 112, a progress prediction unit 113, an input receiving unit 114, and an output generation unit 115.

The attribute value selection unit 111 reads the past project information 121 stored in the storage unit 120, calculates the feature amount, and stores the result in the feature amount information 122. In addition, the attribute value selection unit 111 derives an attribute value (item) correlated with each feature amount of the log information of the past project using the generated feature amount information 122, and stores the derived result in the attribute value information 123.

The past project extraction unit 112 extracts the past project whose attribute value is similar to the log information of the prediction target project in the ordered project information 124 by referring to the feature amount information 122 from the past project information 121.

The progress prediction unit 113 predicts the required completion date for each process of the prediction target project based on the past project similar to the prediction target project extracted by the past project extraction unit 112. In addition, when the required completion date of the prediction target project is predicted for each process, the progress prediction unit 113 stores the result in the required completion date information 125.

The input receiving unit 114 receives the ordered project information transmitted from the user terminal 103 connected via the network 102, the information on the prediction establishment date, the reference period of the past project to be used in the prediction, the allowance range, and the allowance probability. In addition, the input receiving unit 114 has a function of receiving the past project information from the database device 104. Furthermore, the input receiving unit 114 stores the received ordered project information in the ordered project information 124 in the storage unit 120, and stores the received past project information in the past project information 121. In addition, the input receiving unit 114 stores the received prediction establishment date, the past project reference period, the allowance range, and the allowance probability in the set information 126.

The output generation unit 115 transmits the information on the prediction establishment date received by the input receiving unit 114 and the required completion date information 125 to the user terminal 103 connected by the network 102, and generates output information to display the required completion date of each process of the prediction target project to the user.

The communication unit 130 communicates with other devices via the network 102.

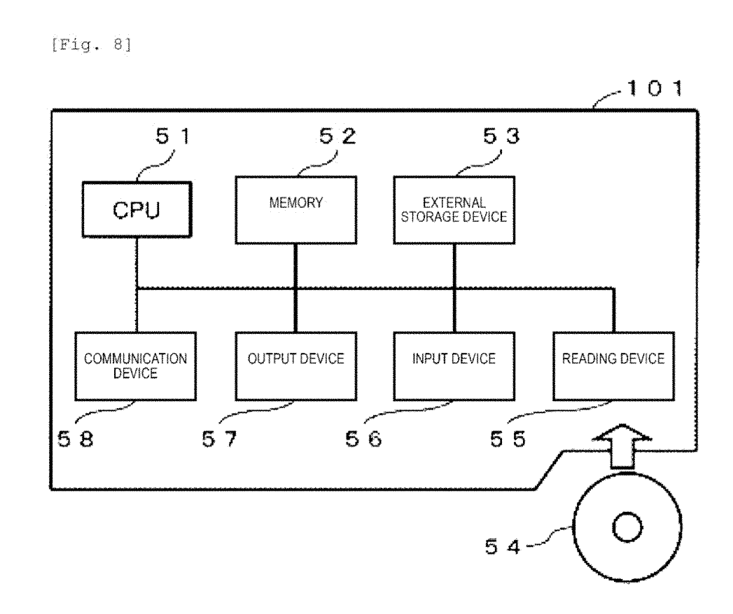

FIG. 8 is a diagram illustrating an example of a hardware structure of the project progress prediction device. The project progress prediction device 101 is realized by a central processing unit (CPU) 51, a memory 52, an external storage device 53 such as a hard disk drive (HDD), a reading device 55 for reading and writing information from and into a portable storage medium 54 such as a compact disk (CD), a digital versatile disk (DVD), an input device 56 such as a keyboard, a mouse, and a barcode reader, an output device 57 such as a display, and a computer including a communication device 58 for communicating with another computer via a communication network such as a network 102, or a computer system including a plurality of such computers.

For example, the calculation unit 110 can be realized by loading a predetermined program stored in the external storage device 53 into the memory 52 and executing the program by the CPU 51, and the storage unit 120 can be realized by the CPU 51 using the memory 52 or the external storage device 53.

This predetermined program may be downloaded to the external storage device 53 from the storage medium 54 via the reading device 55 and loaded onto the memory 52, and then, may be executed by the CPU 51.

The program may also be loaded onto the memory 52 directly from the storage medium 54 via the reading device 55, and may be executed by the CPU 51.

Not being limited thereto, the project progress prediction device 101 may be realized by, for example, an application specific integrated circuit (ASIC) or a microcomputer.

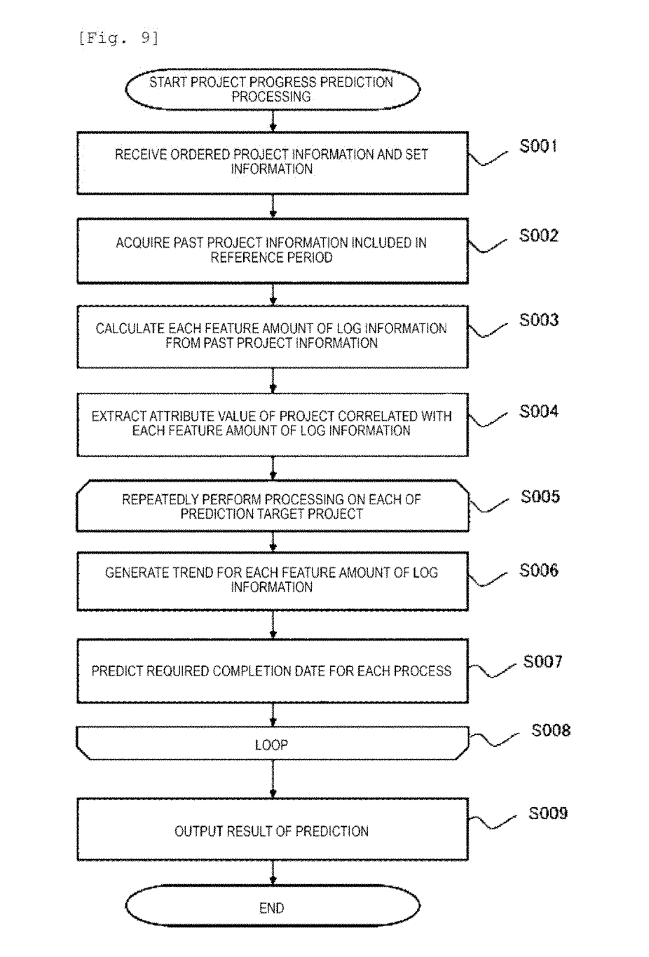

FIG. 9 is a diagram illustrating an example of a flowchart of the project progress prediction processing. The project progress prediction processing is started when an instruction is received from the user.

The project progress prediction processing is started, for example, in response to a start command from the user to the user terminal 103 on a premise that equal to or more than a predetermined number of past project information items are recorded in the database device 104.

First, the user terminal 103 receives the ordered project information, the prediction establishment date which is the set information, the reference period of past project which is to be used in the prediction, the allowance range, and the allowance probability from the user (STEP S001). The user terminal 103 transmits the received information to the project progress prediction device 101 via the network 102.

Next, the input receiving unit 114 acquires the past project information included in the reference period (STEP S002). Specifically, the input receiving unit 114 of the project progress prediction device 101 which received operation information in S001 acquires all the past project information in which a part or all of the period from the order reception to the delivery completion is included in the reference period of the past project received from user terminal 103 in STEP S001 from the database device 104, and stores the information in the past project information 121 stored in the storage unit 120. Furthermore, the input receiving unit 114 stores the ordered project information received from the user terminal 103 in STEP S001 in the ordered project information 124. In addition, the input receiving unit 114 stores the prediction establishment date received from the user terminal 103, the reference period of the past project, the allowance range, and the allowance probability in the set information 126.

Next, the attribute value selection unit 111 calculates each feature amount of the log information from the past project information (STEP S003). Specifically, the attribute value selection unit 111 of the calculation unit 110 calculates each feature amount of the log information of the past project information from the past project stored in the past project information 121, and stores the result of calculation in the feature amount information 122. As a calculation method, there is a method in which the required period of each process is calculated for each project. Hereinafter, an example of processing for calculating each feature amount of the log information of the past project information from the past project information 121 will be described.

The attribute value selection unit 111 calculates the number of elapsed days from the order reception of each project to the design using the progress status field 1218 and the update date field 1219 of the past project information 121. The attribute value selection unit 111 acquires a record whose progress status field 1218 is “order reception completion” and a record whose progress status field 1218 is “design completion”, and calculates the number of elapsed days from order reception to design using the difference between the dates of two records stored in the update date field 1219.

Here, if there are a plurality of records whose progress status field 1218 are “order reception completion”, the record of which the date stored in the update date field 1219 is oldest is acquired. Similarly, if there are a plurality of records whose progress status field 1218 are “design completion”, the record of which the date stored in the update date field 1219 is oldest date is acquire. For example, in the case of the project whose project number field 1211 is “1” in FIG. 2, there are two records whose progress status field 1218 are “order reception completion”. The attribute value selection unit 111 acquires the record of which the date stored in the update date field 1219 is “15/2/24” which is older than the other as a record of “order reception completion”.

Similarly, in the example of FIG. 2, there are two records whose progress status field 1218 is “design completion”. In this case also, the attribute value selection unit 111 acquires a record of which the date stored in the update date field 1219 is “15/4/2” which is older than the other as a record of “design completion”. Thereafter, the attribute value selection unit 111 calculates the number of elapsed days from the order reception to the design using the difference between each acquired date as “15/4/2”−“15/2/24”=“37 days”.

Through the similar processing, the attribute value selection unit 111 respectively calculates the number of elapsed days from the design completion to the production completion, the number of elapsed days from the production completion to the shipment completion, the number of elapsed days from the shipment completion to the delivery completion.

The attribute value selection unit 111 acquires a record whose progress status field 1218 is “design completion” and a record whose progress status field 1218 is “production completion”, and calculates the number of elapsed days from the design completion to the production completion using the difference between the dates stored in the update date field 1219 of the acquired two records. For example, in the case of the project whose project number field 1211 is “1” in FIG. 2, the attribute value selection unit 111 acquires “15/4/2” as the date corresponding to the “design completion” and acquires “15/8/2” as the date corresponding to the “production completion”, and then, calculates the number of elapsed days from the design completion to the production completion from the difference between the two dates as “15/8/2”−“15/4/2”=“122 days”.

The attribute value selection unit 111 acquires a record whose progress status field 1218 is “production completion” and a record whose progress status field 1218 is “shipment completion”, and calculated the number of elapsed days from the production completion to the shipment completion using the difference between the dates stored in the update date field 1219 of the acquired two records. For example, in the case of the project whose project number field 1211 is “1” in FIG. 2, the attribute value selection unit 111 acquires “15/8/2” as the date corresponding to the “production completion” and “15/9/10” as the date corresponding to the “shipment completion”, and then, calculates the number of elapsed days from the production completion to the shipment completion from the difference between the two dates as “15/9/10”−“15/8/2”=“39 days”.

The attribute value selection unit 111 acquires a record whose progress status field 1218 is “shipment complete” and a record whose progress status field 1218 is “delivery completed”, and calculates the number of elapsed days from the shipment completion to the completion of delivery using the difference between the dates stored in the update date field 1219 of the acquired two records. For example, in the case of the project whose project number field 1211 is “1” in FIG. 2, the attribute value selection unit 111 acquires “15/9/10” as the date corresponding to the “shipment completion” and acquires “15/9/20” as the date corresponding to the “delivery completed”, and then, calculates the number of elapsed days from the shipment completion to the delivery completion using the difference between the two dates as “15/9/20”−“15/9/10”=“10 days”.

The attribute value selection unit 111 aggregates the number of times the date stored in the delivery date field 1217 of the past project information 121 is changed on a project basis, and calculates the number of times of changing the delivery date. For example, in the case of the project whose project number is “1” in FIG. 2, the dates in the delivery date field 1217 is changed in three times as “15/7/30”→“15/8/30”→“15/9/5”→“15/9/30” on the project basis, the attribute value selection unit 111 calculates the number of times of changing the delivery date as three times.

Then, with regard to the date stored in the delivery date field 1217 in the past project information 121, the attribute value selection unit 111 calculates the advanced or delayed days of the delivery date at the time of delivery to the customer compared to the delivery date registered at the time of ordering, and then, calculates the content of changing the delivery date. For example, in the case of the project whose project number field 1211 is “1” in FIG. 2, the attribute value selection unit 111 reads a fact that the delivery date at the time of order reception is “15/7/30” and that the final delivery date is “15/9/30” from the delivery date field 1217. The attribute value selection unit 111 calculates a fact that there is “62 day delay” from the fact that “15/7/30”−“15/9/30”=“−62 days”, as the content of changing the delivery date.

Next, the attribute value selection unit 111 stores each feature amount (number of elapsed days for each process) of the calculated log information of the past project information in the feature amount information 122. Specifically, the attribute value selection unit 111 stores the project number in the project number field 1221, stores the number of elapsed days from the order reception to the design completion in the number of elapsed days (from the order reception to the design completion) field 1222, stores the number of elapsed days from the design completion to the production completion in the number of elapsed days (from the design completion to the production completion) field 1223, stores the number of elapsed days from the production to the shipment in the number of elapsed days (from the production completion to the shipment completion) field 1224, stores the number of elapsed days from the shipment to the delivery in the number of elapsed days (from the shipment completion to the delivery completion) field 1225, stores the number of times of changing the delivery date in the number of times of changing the delivery date field 1226, and stores the content of changing the delivery date in the content of changing the delivery date field 1227. For example, in the case of the project whose project number is “1” in FIG. 2, the attribute value selection unit 111 stores “1” in the project number field 1221, stores “37 days” in the number of elapsed days (from the order reception to the design completion) field 1222, stores “122 days” in the number of elapsed days (from the design completion to the production completion) field 1223, stores “39 days” in the number of elapsed days (from the production completion to the shipment completion) field 1224, stores “10 days” in the number of elapsed days (from the shipment completion to the delivery completion) field 1225, stores “three times” in the number of times of changing the delivery date field 1226, and stores “62 days delayed” in the content of changing the delivery date field 1227.

Next, the attribute value selection unit 111 extracts the attribute value of the project correlated with each feature amount of the log information (STEP S004). Specifically, the attribute value selection unit 111 extracts the attribute value correlated with each feature amount (the number of elapsed days) of the log information of the past project information using the feature amount information 122, and stores the extracted attribute values in the attribute value information 123.

Hereinafter, an example of the processing for extracting the attribute values correlated with the number of elapsed days from the order reception to the design completion will be described in detail below. The attribute value selection unit 111 extracts the attribute values each correlated with the number of elapsed days from the design to the production completion, which is the feature amount of other log information of the past project, the number of elapsed days from the production completion to the shipment completion, the number of elapsed days from the shipment completion to the delivery completion, the number of times of changing the delivery date, and the content of changing the delivery date, through the similar processing.

There are several methods for extracting the correlated attribute values, and in this example, an example using correlation ratios commonly used in correlation analysis will be described. First, the attribute value selection unit 111 calculates the correlation ratio of each attribute value, and analyze the correlation between the number of elapsed days from the order reception to the design completion and each of the attribute values. By taking an example of the type industry among the attribute values, the method of calculating the correlation ratio will be described. First, in order to calculate the correlation ratio, the attribute value selection unit 111 calculates an average value of the numbers of elapsed days from the order reception to the design completion of all the records stored in the feature amount information 122. In the example of the feature amount information 122 in FIG. 3, the attribute value selection unit 111 calculates the average value of the numbers of elapsed days from the order reception to the design completion as (37 days+90 days+37 days++50 days)/100=70 days.

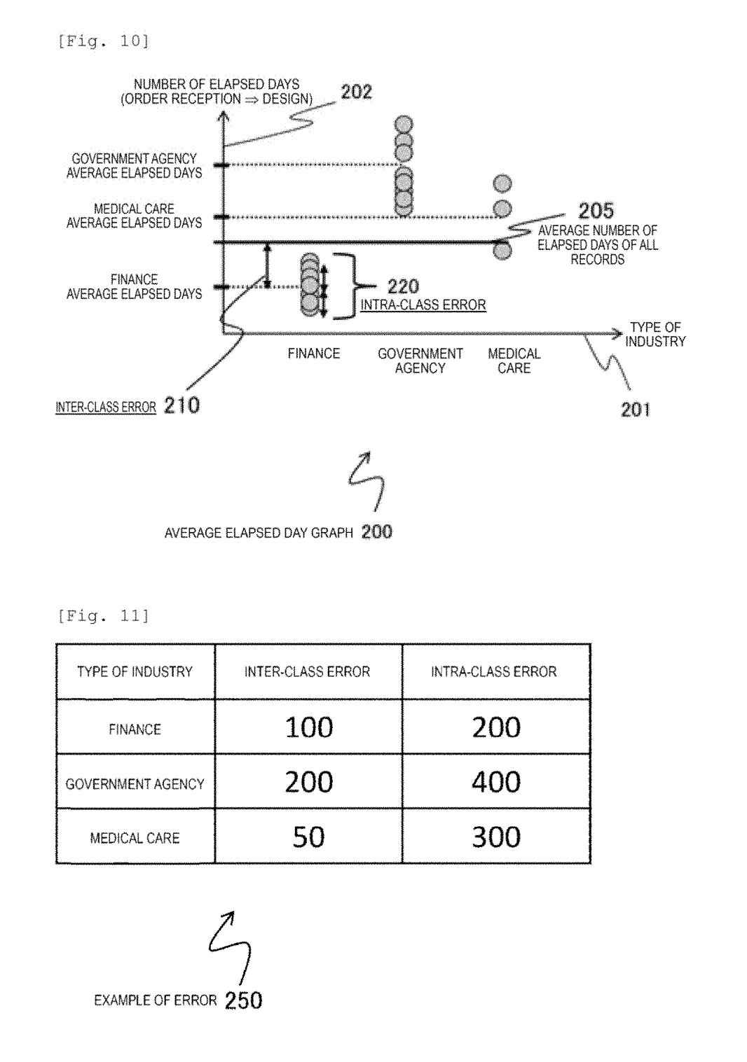

Next, the attribute value selection unit 111 reads the past project information 121, groups each of the records in the feature amount information 122 into each type of industry such as “finance”, “government agency”, “medical care”, and calculate an inter-class error and an intra-class error for each type of industry. Here, the inter-class error in the present embodiment is a square error of the average value of all the records and the average value of the records of each type of industry. In addition, the intra-class error in the present embodiment is a square sum error of the average value of the records of each type of industry and each of the records. FIG. 10 illustrates an example of the intra-class error and the inter-class error. FIG. 11 illustrates an example of the result of calculation of the intra-class error and the inter-class error for each type of industry.

FIG. 10 is a diagram illustrating an example in which the intra-class error and the inter-class error are visualized. In FIG. 10, an average number of elapsed day graph 200 is illustrated. The average number of elapsed day graph 200 is a two-dimensional graph in which the type of industry is indicated on an X axis 201 and the number of elapsed days of the process is indicated on a Y axis 202. The performance of the number of elapsed days of all processes, that is, the processes of all the projects are represented as the total record average number of elapsed days 205, an error width between the average number of elapsed days of the type of industry and the average number of elapsed days 205 of all records is represented as the inter-class error 210, and an error width between the average number of elapsed days of the project within the type of industry and the number of elapsed days of the individual project is represented as the intra-class error 220.

FIG. 11 is a diagram illustrating an example of the result of calculation of intra-class error and the inter-class error. In FIG. 11, an error example 250 is illustrated. The inter-class error of the type of industry “finance” is 100 and the intra-class error thereof is 200. In addition, the inter-class error of the type of industry “government agency” is 200, and the intra-class error thereof is 400. The inter-class error of the type of industry “medical care” is 50, and the intra-class error thereof is 300.

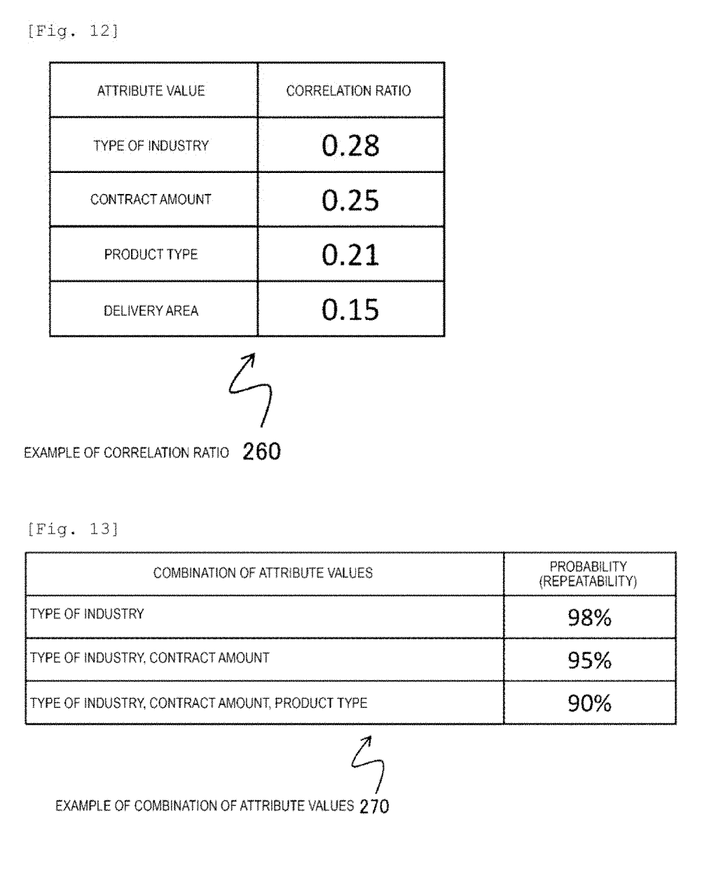

Then, the attribute value selection unit 111 calculates the correlation ratio using (sum of the intra-class errors of each type of industry)/(sum of the intra-class errors of each type of industry+sum of inter-class errors of each type of industry). In a case of the error example 250, the attribute value selection unit 111 calculates the correlation ratio of the attribute value of the “type of industry” as (100+200+50)/(100+200+50+200+400+300)=0.28. The attribute value selection unit 111 also performs the processing for calculating the above correlation ratio for other attribute values. An example of the result of calculation of the correlation ratio of each attribute value is illustrated in FIG. 12.

FIG. 12 is a diagram illustrating an example of the result of calculation of the correlation ratio. In FIG. 12, as a correlation ratio example 260, the attribute values are rearranged in a descending order of the correlation ratio. In the correlation ratio example 260, the correlation ratio for each of the single attribute values are 0.28 for the attribute value “type of industry”, 0.25 for the attribute value “contract amount”, 0.21 for the attribute value “product type”, and 0.15 for the attribute value “delivery area”.

Subsequently, the attribute value selection unit 111 combines the attribute values in an order of large correlation ratio, and determine the number of attribute values to be used for the extraction. In the present embodiment, in order to consider the repeatability of the past trend, the idea of statistical confidence interval is applied. The attribute value selection unit 111 sequentially combines the attribute values in an order of a large correlation ratio and determines whether or not the confidence interval of the average value of the records grouped under the condition of the combined attribute value is equal to or higher than the designated allowance probability and falls within the allowance range. If the confidence interval is equal to or higher than the designated allowance probability and falls within the allowance range, the attribute value selection unit 111 further evaluates the confidence interval by combining the attribute values, and if not falls within the allowance range, ends the processing for evaluating the combination of the attribute values, and then, determines the combination of the attribute values that finally falls within the allowance range as the number of attribute values.

For the allowance range of the confidence interval and the allowance probability used in this processing, the information stored in the allowance range field 1264 and the allowance probability field 1265 in the set information 126, are respectively used. In a case of the set information 126 illustrated in FIG. 7, the attribute value selection unit 111 performs the processing with the allowance range as “within 30 days” and allowance probability as “95%”.

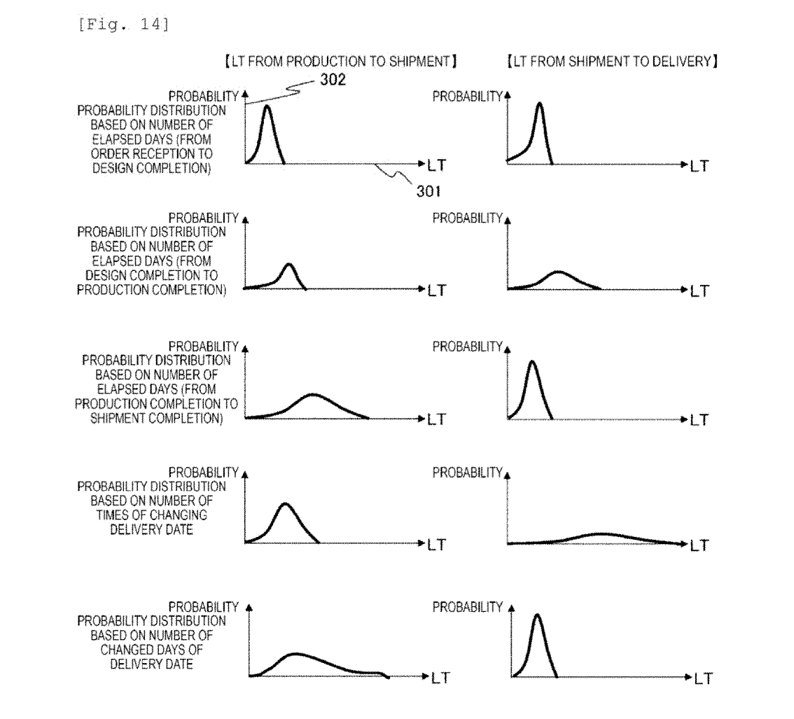

FIG. 13 is a diagram illustrating an example of the result of calculation of the probability for determining the combination of the attribute values to be extracted. In FIG. 13, the probability (repeatability) that the confidence interval falls within the allowance range is illustrated in the case of combining the attribute values in an order of the large correlation ratio illustrated in FIG. 12. When the set condition illustrated in FIG. 7 is used, if the allowance probability that falls within the allowance range of the confidence interval is set to “equal to or higher than 95%”, since the repeatability of the combination of attribute values “type of industry, contract amount, and product type” is “90%”, it can be said that the repeatability is lower than the allowance probability. In this case, the attribute value selection unit 111 determines “type of industry, contract amount” that falls within allowance probability (95% or more) as a combination of attribute values to be extracted. The attribute value selection unit 111 stores the “type of industry and contract amount” which is the result of extraction in the number of elapsed days (from the order reception to the design completion) field 1221 of the attribute value information 123.

The evaluation method based on the correlation ratio and the confidence interval is illustrated in the present embodiment, however, the extraction of the attribute value is not limited to this method, and other methods may be used.

The attribute value selection unit 111 extracts the correlated attribute values through the similar processing for each of the number of elapsed days from the design completion to the production completion, the number of elapsed days from the production completion to the shipment completion, the number of elapsed days from the shipment completion to the delivery completion, the number of times of changing the delivery date, and the content of changing the delivery date, and respectively stores the combination of each attribute values in the number of elapsed days (from the design completion to the production completion) field 1232, in the number of elapsed days (from the production completion to the shipment completion) field 1233, in the number of elapsed days (from the shipment completion to the delivery completion) field 1234, in the number of times of changing the delivery date field 1235, and in the content of changing the delivery date field 1236 of the attribute value information 123.

Subsequently, the past project extraction unit 112 and the progress prediction unit 113 repeatedly performs the processing items in STEPs S006 and S007 on each of the prediction target projects stored in the ordered project information 124 (STEP S005 and STEP S008)

The past project extraction unit 112 generates a trend for each feature amount of the log information (STEP S006). Specifically, the past project extraction unit 112 extracts the past project (delivery completed project) whose log information is similar to that of the prediction target project stored in the ordered project information 124 to be predicted, by comparing with the past project information 121 and the feature amount information 122, and generates a probability distribution (trend) of lead time (hereinafter referred to as LT) up to the non-completed process of the prediction target project for each feature amount (for each process) of the log information.

For example, the past project extraction unit 112 calculates each feature amount of the log information of the prediction target project from ordered project information 124 through the processing similar to STEP S003. However, since the all processes up to the delivery are not completed, in the prediction target project, the feature amounts of a part of the processes cannot be calculated among feature amounts of the number of elapsed days from the order reception to the design completion, the number of elapsed days from the design completion to the production completion, the number of elapsed days from the production completion to the shipment completion, and the number of elapsed days from the shipment completion to the delivery completion. Therefore, the past project extraction unit 112 calculates the feature amount including only the process currently completed through the process same as in STEP S003, and for the feature amount including the process next to the process currently completed, the number of elapsed days is temporally calculated based on the difference between the prediction establishment date and the update date of the completed process. The feature amount including the process one after next to the process currently completed is not calculated.

In a case of the project of which the project number field 1241 illustrated in FIG. 5 is “a”, the production process is currently completed. Therefore, the past project extraction unit 112 calculates the number of elapsed days from the order reception to the design completion and the number of elapsed days from the design completion to the production completion through the same processing similar to STEP S003, and the results of the calculation of the numbers of elapsed days are “17/3/10”−“17/2/1”=“37 days” and “17/4/20”−“17/3/10’=“41 days”. In addition, the past project extraction unit 112 calculates the number of elapsed days from the production completion to the shipment completion based on the difference between the prediction establishment date and the update date of production completion. In FIG. 5, since the prediction establishment date of the data is “15/5/1”, the past project extraction unit 112 calculates the number of elapsed days from the production completion to the shipment completion as “17/5/1”−“‘17/4/20”=“11 days”. The past project extraction unit 112 does not calculate the feature amount for the number of elapsed days from the shipment completion to the delivery completion including the process “delivery” that is one after next to the “production” which is currently completed.

The past project extraction unit 112 performs the processing similar to STEP S003 for the number of times of changing the delivery date and the content of changing the delivery date. In a case of the project of which the project number 1241 illustrated in FIG. 5 is “a”, the number of times of changing the delivery date is calculated as “1”, and the content of changing the delivery date is calculated as “31 days advanced” from “17/6/30”−“17/5/30”=“31”.

Next, the past project extraction unit 112 extracts the past project whose attribute value is similar to the log information of the prediction target project calculated above from each feature amount of the log information, and calculates the probability distribution of the LT up to the non-completed process of the prediction target project. However, the past project extraction unit 112 does not extract the past project for the feature amount not calculated in the log information of the above prediction target project.

In the example in FIG. 5, in a case of the project of which the project number 1241 is “a”, since the project is in a state in which the production is completed and the shipment is not completed, the past project extraction unit 112 does not calculate the number of elapsed days from shipment completion to the delivery completion. For this reason, for the past project similar to the prediction target project, the extraction processing is not performed for this feature amount.

Hereinafter, the content of processing by the past project extraction unit 112 will be described by taking the number of elapsed days from the order reception to the design completion among the feature amounts of the log information as an example. Through the similar processing, the past project extraction unit 112 extracts the past project similar to the prediction target project in each of the number of elapsed days from the design completion to the production completion, the number of elapsed days from the production completion to the shipment completion, the number of elapsed days from the shipment completion to the delivery completion, the number of times of changing the delivery date, and the content of changing the delivery date, and generates the probability distribution of the LT up to non-completed process.

First, the past project extraction unit 112 extracts the past project of which the number of elapsed days from the order reception to the design is same as that of the prediction target project or similar to that in a certain degree (for example, an error of approximately 10% is allowed or the allowance range of the error is designated by the user) from the feature amount information 122. For example, in a case of the project of which the project number 1241 illustrated in FIG. 5 is “a”, since the number of elapsed days from the order reception to the design completion is 37 days, the past project extraction unit 112 extracts the past project of which the number of elapsed days (from the order reception to the design completion) field 1222 is 37 days or 33 to 41 days from the feature amount information 122. In a case of the feature amount information 122 illustrated in FIG. 3, the past project extraction unit 112 extracts the past project (project number “1” and “3”) of which the number of elapsed days (from the order reception to the design completion) field 1222 is 37 days.

Next, the past project extraction unit 112 extracts a past project of which the attribute value matches that of the prediction target project from the extracted past project based on the attribute value stored in the attribute value information 123. For the number of elapsed days from the order reception to the design completion, the past project extraction unit 112 extracts the past project of which the attribute value stored in the number of elapsed days (from the order reception to the design completion) field 1231 of the attribute value information 123 is similar to that of the prediction target project. For example, in the example in FIG. 3, the past project extraction unit 112 extracts the past project whose contents of the “type of industry” and the “contract amount” match that of the prediction target project or similar to that in a certain degree (for example, the digit of the amount in the contract amount matches each other or the allowance range of the error is designated by the user).

For example, among the order reception projects in FIG. 5, in a case of the project of which the project number 1241 is “a”, since the type of industry is “finance” and the contract amount is “10M yen”, the project extraction unit 112 extracts the past project whose type of industry is “finance” and the contract amount is similar to “10M yen” from the previously extracted past project. If there are past projects whose project number is “1”, “2”, or 3, the past project extraction unit 112 extracts the past project whose project number is “1” as a similar project.

The past project extraction unit 112 generates the probability distribution of the LT of the non-completed process excluding the process currently completed based on the extracted past project. In a case of the project of which the project number 1241 illustrated in the example in FIG. 5 is “a”, since the non-completed processes are the “shipment” and the “delivery”, using the extracted past project, the probability distribution of LT from the production completion to the shipment completion and the probability distribution of the LT from the shipment completion to the delivery completion are generated. The past project extraction unit 112 generates the probability distribution of the LT from the production completion to the shipment completion using the number of elapsed days from the production completion to the shipment completion of the extracted past project, and generates the probability distribution of the LT from the shipment completion to the delivery completion using the number of elapsed days from the shipment completion to the delivery completion of the extracted past project.

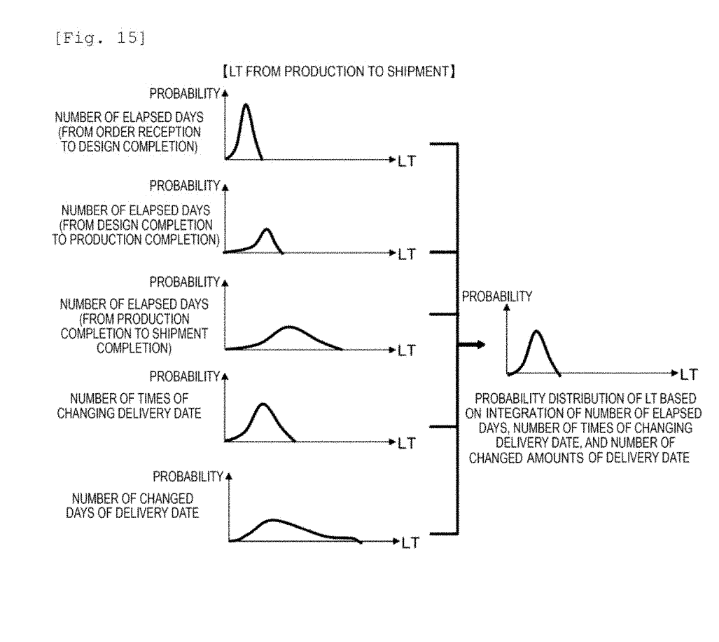

The past project extraction unit 112 performs the processing performed on the number of elapsed days from the order reception to the design completion also on each of the number of elapsed days from the design completion to the production completion, the number of elapsed days from the production completion to the shipment completion, the number of elapsed days from the shipment completion to the delivery completion, the number of times of changing the delivery date, the content of changing the delivery date. However, if the project number 1241 of a project illustrated in FIG. 5 is “a”, since only the production is completed, the past project extraction unit 112 does not calculate the LT for the number of elapsed days from the shipment completion to the delivery completion. In FIG. 14, for the project of which the project number 1241 is “a” in the example in FIG. 5, the probability distributions of the LT up to the non-completed process that is generated for each feature amount of the log information by the past project extraction unit 112 are illustrated.

FIG. 14 is a diagram illustrating an example of trends for each feature amount of the log information. In FIG. 14, the probability distribution of the LT of non-completed process from the production to the shipment and the probability distribution of the LT of non-completed process from the shipment to the delivery are illustrated. Each probability distribution is the result of calculating the LT probability distribution of non-completed process based on the feature amount of the process of interest among the feature amounts of multiple processes of the past similar project. In the present embodiment, the probability distribution is represented by a two-dimensional graph with the LT on the X axis 301 and the probability on the Y axis 302.

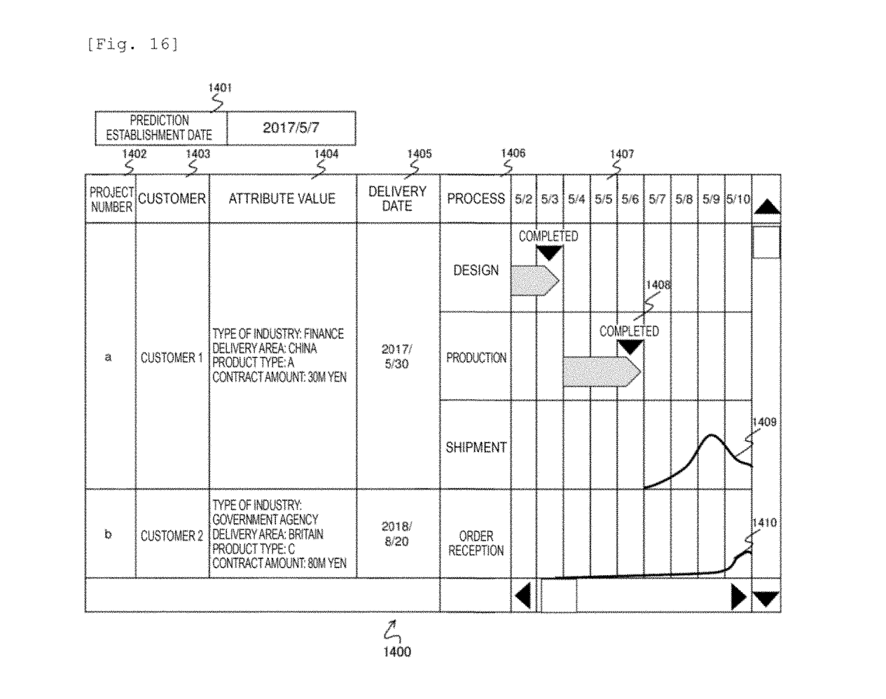

Next, the progress prediction unit 113 predicts the required completion date for each process (STEP S007). Specifically, the progress prediction unit 113 predicts the required completion date for each process of the prediction target project by combining the trend (probability distribution of the LT) for each feature amount of the log information generated by the past project extraction unit 112 in STEP S006. In this processing, first, the progress prediction unit 113 predicts the probability distribution of each of the LTs of the non-completed process of the final prediction target project the as the completion date by combining the trends for each feature amount of the log information generated by the past project extraction unit 112 in STEP S006. In the present embodiment, the trends for each feature amount of the log information is combined using the Bayesian estimation that is often used in statistics. However, the present invention is not limited thereto, and other methods may be used. FIG. 15 illustrates an example of the result of deriving the probability distribution of the LT from the production to the shipment based on the compound feature amount in which the trends for each feature amount of the log information illustrated in FIG. 14 are combined.

FIG. 15 is a diagram illustrating an example of the result of combination of the trends for each feature amount of the log information. On the left side of an arrow in FIG. 15, the results of estimation of the probability distribution of the LT from the production completion to the shipment completion based on each feature amount are illustrated. By integrating the results by the Bayesian estimation, the result of estimation of the integrated LT probability distribution is obtained on the right side of the arrow.

The progress prediction unit 113 predicts the required completion date of the non-completed process based on the probability distribution of the LT derived by the Bayesian estimation. To that end, the progress prediction unit 113 calculates an average value of the probability distribution of the LT, and calculates the required completion date of the non-completed process by adding the calculated average value to the update date of the currently completed process. In the present embodiment, the average value of the probability distribution of LT is added to the update date of the currently completed process, but the number of days calculated by statistical sampling such as the Monte Carlo method may be added.

In the example in FIG. 5, in a case of the project of which the project number 1241 is “a”, it is assumed that the progress prediction unit 113 calculates the average value of LT from the production completion to the shipment completion as 15 days, and calculates the average value of LT from the shipment completion to the delivery completion as 15 days. In addition, in FIG. 5, since the date on which the production is completed is “17/4/20”, the progress prediction unit 113 calculates the required completion date of the shipment as “17/4/20”+15 (day)=“17/5/5”, and calculates the required completion date of the delivery as “17/4/20”+15 (day)+15 (day)=“17/5/20”.

The progress prediction unit 113 stores the required completion date of the predicted non-completed process in the required completion date information 125 together with the process information. In FIG. 5, in a case of the project of which the project number 1241 is “a”, when storing the required completion date of shipment, the progress prediction unit 113 stores “a” in the project number field 1251, “shipment completion” in the process field 1252, and “17/5/5” in the required completion date field 1253.

The output generation unit 115 generates an output screen 1400 indicating result of prediction of the required completion date for each process of the prediction target project based on the ordered project information 124 and the required completion date information 125, and transmits the output screen 1400 to the user terminal 103 via the network 102 to display the screen (STEP S009). The above-described is the flow of the project progress prediction processing. FIG. 16 illustrates an example of the output screen 1400.

FIG. 16 is a diagram illustrating an example of the output screen. In FIG. 16, an example of the output screen 1400 is illustrated. In the output screen 1400, the prediction establishment date field 1401, the project number field 1402, the customer field 1403, the attribute value field 1404, the delivery date field 1405, the process field 1406, a date field 1407, a completion mark 1408, a first LT probability distribution graph 1409 and a second LT probability distribution graph 1410.

In the prediction establishment date field 1401, the information on the prediction establishment date designated by the user is displayed. In the project number field 1402, the project number of the prediction target project is displayed. In the customer field 1403, the customer name of the prediction target project is displayed. In the attribute value field 1404, the attribute value of the prediction target project is displayed. In the delivery date field 1405, the delivery date of the prediction target project is displayed. In the process field 1406, the target process is displayed. In the date field 1407, the date is displayed. For each process, the completion mark 1408, or the first LT probability distribution graph 1409 and the second LT probability distribution graph 1410 is displayed.

The completion mark 1408 is provided at the position of the date corresponding to the completion date of the completed process. The first LT probability distribution graph 1409 is provided at the position of the date corresponding to the completion date of the process next to the completed process, that is, the process in progress, with the date on the horizontal axis and the probability on the vertical axis. The second LT probability distribution graph 1410 is provided at the position of the date corresponding to the completion date of the process one after next to the completed process, that is, the process not started yet, with the date on the horizontal axis and the probability on the vertical axis.

The above-described is the project progress prediction system according to the embodiment of the present invention. According to the project progress prediction system, it is possible to predict the required completion date of the product for each process with high accuracy, of which the registration information including the delivery date of the project changes frequently.

The project progress prediction device and the project progress prediction system according to the embodiment of the present invention generate the trend for each feature amount of the log information and predict a required completion date for each process by combining the trends for each feature amount. In this way, it becomes possible to predict the required completion date for each process with high accuracy, which is not possible in the related art.

### REFERENCE SIGNS LIST

100 project progress prediction system
101 project progress prediction device
102 network
103 user terminal
104 database
110 calculation unit
111 attribute value selection unit
112 past project extraction unit
113 progress prediction unit
114 input receiving unit
115 output generation unit
120 storage unit
121 past project information
122 feature amount information
123 attribute value information
124 ordered project information
125 required completion date information
126 set information
130 communication unit
1400 output screen

1. A project progress prediction device comprising:
a storage unit that stores log information which is a change history of an attribute value of a project and a feature amount of a delivery date including the number of elapsed days for each process;
an attribute value selection unit that selects an attribute value having a predetermined correlation with the delivery date of the project using the log information;
a past project extraction unit that extracts a completed project having the attribute value similar to that of a prediction target project from the storage unit using the selected attribute value, and estimates a lead time for each of the feature amounts for non-completed processes of the prediction target project using the feature amount of the delivery date of the extracted completed project; and
a progress prediction unit that integrates the estimated lead times between the feature amounts and predicts a probability of a required completion date for each process of the prediction target project.

2. The project progress prediction device according to claim 1,
wherein the attribute value selection unit extracts the feature amount relating to at least the number of elapsed days for each process of the project from the log information, and estimates a lead time which is based on the number of elapsed days for each of the non-completed processes of the prediction target project.

3. The project progress prediction device according to claim 1,
wherein the attribute value selection unit extracts the feature amounts relating to at least the number of elapsed days for each process of the project and the number of times of changing the delivery date from the log information, and estimates a lead time which is based on the number of elapsed days for each process and a lead time which is based on the number of times of changing the delivery date, for each of the non-completed processes of the prediction target project.

4. The project progress prediction device according to claim 1,
wherein, in selecting the attribute value having a predetermined correlation with the delivery date of the project, the attribute value selection unit selects a combination of the attribute values such that the delivery date has a correlation equal to or greater than a predetermined value with regard to a plurality of combinations of the attribute values and a repeatability satisfies a predetermined criterion.

5. The project progress prediction device according to claim 1,
wherein, in selecting the attribute value having a predetermined correlation with the delivery date of the project, the attribute value selection unit selects a combination of the attribute values such that the correlation of the attribute value using an inter-class error and an intra-class error with the delivery date is equal to or greater than a predetermined value for a plurality of combinations of the attribute values and a confidence interval satisfies a predetermined criterion when the attribute values are combined in an order of high correlation.

6. The project progress prediction device according to claim 1,
wherein, in processing for integrating the estimated lead times between the feature amounts, the progress prediction unit integrates the estimated lead times between the feature amounts using the Bayesian estimation and predicts a probability of the required completion date.

7. The project progress prediction device according to claim 1, further comprising:
an output generation unit that generates a completion date of the completed processes of the prediction target project, and a probability of the required completion date of the non-completed processes estimated by the progress prediction unit, as an output.

8. A project progress prediction system comprising:
a storage unit that stores log information which is a change history of an attribute value of a project and a feature amount of a delivery date including the number of elapsed days for each process;
an attribute value selection unit that selects an attribute value having a predetermined correlation with the delivery date of the project using the log information;
a past project extraction unit that extracts a completed project having the attribute value similar to that of a prediction target project from the storage unit using the selected attribute value, and estimates a lead time for each of the feature amounts for non-completed processes of the prediction target project using the feature amount of the delivery date of the extracted completed project; and
a progress prediction unit that integrates the estimated lead times between the feature amounts and predicts a probability of a required completion date for each process of the prediction target project.
